(19) United States
(12) Patent Application Publication
(10) Pub. No.: US 2014/0195658 A1
(43) Pub. Date: Jul. 10, 2014

(54) REDUNDANCY ELIMINATION SERVICE ARCHITECTURE FOR DATA CENTER NETWORKS

(71) Applicants: Krishna P. Puttaswamy Naga, San Jose, CA (US); Ashok Anand, Bangalore (IN)

(72) Inventors: Krishna P. Puttaswamy Naga, San Jose, CA (US); Ashok Anand, Bangalore (IN)

(21) Appl. No.: 13/737,184

(22) Filed: Jan. 9, 2013

(51) Int. Cl. H04L 12/24

(52) U.S. Cl. CPC H04L 41/04
USPC 709/223

(57) ABSTRACT

A redundancy elimination (RE) capability is provided. The RE capability enables dynamic control over use of RE within a network. The dynamic control over use of RE within a network may include initial selection of the network locations at which RE is performed, dynamic modification of the network locations at which RE is performed, or the like. The dynamic control over use of RE within a network may include dynamic control over packet cache sizes of packet caches at the network locations at which RE is performed. The dynamic control over use of RE within a network may include determining RE component selection information for a set of nodes of the network and selecting a set of RE components for the set of nodes, from a set of available RE components of the network, based on the RE component selection information.

### TECHNICAL FIELD

The disclosure relates generally to communication networks and, more specifically but not exclusively, to redundancy elimination in communication networks.

### BACKGROUND

As the use of data center networks to host applications and data continues to grow, the volume of data transfers between virtual machines within data centers and across data centers of the same cloud service provider also continues to grow. Given this continued growth, reduction of latency and increases in available bandwidth continue to be of concern despite the large amount of bandwidth typically supported within such data centers. Redundancy Elimination (RE) is one technique for improving effective latency and bandwidth within data center networks.

### SUMMARY OF EMBODIMENTS

Some simplifications may be made in the following summary, which is intended to introduce and highlight some aspects of the various exemplary embodiments, but such simplifications are not intended to limit the scope of the inventions. Detailed descriptions of a preferred exemplary embodiment adequate to allow those of ordinary skill in the art to make and use the inventive concepts will follow in later sections.

Various deficiencies in the prior art may be addressed by embodiments for providing redundancy elimination (RE) in a communication network.

In one embodiment, an apparatus is configured to support RE in a network. The apparatus includes a processor and a memory communicatively connected to the processor. The processor is configured to determine RE component selection information for a set of nodes of a network and select a set of RE components for the set of nodes based on the RE component selection information. The network includes a plurality of network elements and a set of available RE components available to perform RE functions within the network. The set of available RE components includes at least three RE components. The set of RE components is selected from the set of available RE components and includes at least two of the available RE components.

In one embodiment, a computer-readable storage medium stores instructions which, when executed by a computer, cause the computer to perform a method for supporting RE in a network. The method includes determining RE component selection information for a set of nodes of a network and selecting a set of RE components for the set of nodes based on the RE component selection information. The network includes a plurality of network elements and a set of available RE components available to perform RE functions within the network. The set of available RE components includes at least three RE components. The set of RE components is selected from the set of available RE components and includes at least two of the available RE components.

In one embodiment, a method for supporting RE in a network is provided. The method includes using a processor and a memory for determining RE component selection information for a set of nodes of a network and selecting a set of RE components for the set of nodes based on the RE component selection information. The network includes a plurality of network elements and a set of available RE components available to perform RE functions within the network. The set of available RE components includes at least three RE components. The set of RE components is selected from the set of available RE components and includes at least two of the available RE components.

### BRIEF DESCRIPTION OF THE DRAWINGS

The teachings herein can be readily understood by considering the following detailed description in conjunction with the accompanying drawings, in which:

FIG. 1 depicts an exemplary data center network configured to support redundancy elimination for virtual machines using redundancy elimination components;

FIG. 2 depicts examples of intra-node redundancy elimination and inter-node redundancy elimination;

FIG. 3 depicts one embodiment of a method for configuring a set of redundancy elimination components to perform redundancy elimination for a set of virtual machines within the exemplary within the exemplary data center network of FIG. 1;

FIG. 4 depicts one embodiment of a method for reconfiguring a set of redundancy elimination components based on measurement information received from the redundancy elimination components;

FIG. 5 depicts one embodiment of a method for selecting a set of redundancy elimination components of a communication network to perform redundancy elimination for a set of nodes configured to communicate via the communication network; and

FIG. 6 depicts a high-level block diagram of a computer suitable for use in performing functions described herein.

To facilitate understanding, identical reference numerals have been used, where possible, to designate identical elements that are common to the figures.

### DETAILED DESCRIPTION OF EMBODIMENTS

In general, a dynamic redundancy elimination (RE) capability is provided herein.

In at least some embodiments, the dynamic RE capability enables dynamic control over use of RE within a network. In at least some embodiments, the dynamic control over use of RE within a network may include initial selection of the network locations at which RE is performed, dynamic modification of the network locations at which RE is performed, or the like. In at least some embodiments, the dynamic control over use of RE within a network may include dynamic control over packet cache sizes of packet caches at the network locations at which RE is performed. It will be appreciated that the dynamic RE capability may enable dynamic control over various other aspects of RE within a network.

In at least some embodiments, the dynamic RE capability enables selection of a set of RE components to be used to provide RE for a set of nodes which may communicate via a network. The set of RE components selected for the set of nodes may be selected from a set of available RE components which are available within the network to provide RE functions for communications within the network. The RE components may be associated with network elements supporting communications within the network. The set of RE components selected for the node may be selected based on RE selection information associated with the set of nodes (e.g., network location information, network topology information, traffic pattern information, RE measurement information, or the like, as well as various combinations thereof).

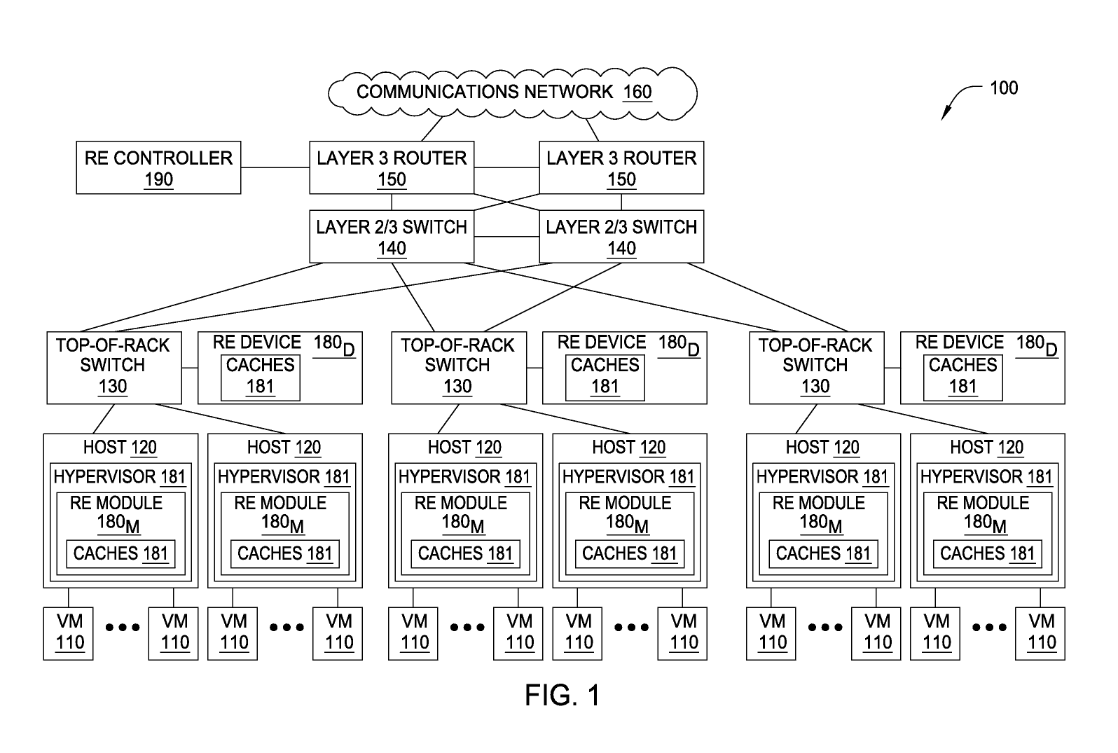

It will be appreciated that, although primarily depicted and described herein with respect to embodiments in which the dynamic RE capability is used within a data center network to provide RE functions for communications between virtual machines (VMs) hosted within the data center network, various embodiments of the dynamic RE capability may be adapted for use in various other types of communication networks supporting communications between various other types of nodes. FIG. 1 depicts an exemplary data center network configured to support redundancy elimination for virtual machines using redundancy elimination components.

As depicted in FIG. 1, the exemplary data center network 100 includes a plurality of virtual machines (VMs) 110, a plurality of hosts 120, a plurality of top-of-rack (ToR) switches 130, a pair of layer2/3 switches 140, a pair of layer 3 routers 150, and a communication network 160.

The VMs 110 are associated with respective ones of the hosts 120. It will be appreciated that each host 120 may support one or more VMs 110; however, for purposes of clarity, only a small number of VMs 110 are depicted in FIG. 1. The exemplary data center network 100 of FIG. 1 includes six hosts 120 (although it will be appreciated that a data center network may include fewer or more hosts 120).

The hosts 120 are communicatively connected to respective ones of the ToR switches 130. The exemplary data center network 100 of FIG. 1 includes three ToR switches 130, each having two of the six hosts 120 communicatively connected thereto (although it will be appreciated that a data center network may include fewer or more ToR switches 130, that ToR switches 130 may support fewer or more hosts 120, or the like). The hosts 120 include a respective plurality of hypervisors 121.

The ToR switches 130 each are communicatively connected to both of the layer 2/3 switches 140 (although it will be appreciated that a data center network may include fewer or more layer 2/3 switches 140, that layer 2/3 switches 140 may support fewer or more ToR switches 130, that each of the ToR switches 120 may or may not be redundantly connected to multiple layer 2/3 switches 140, or the like).

The layer 2/3 switches 140 each are communicatively connected to both of the layer 3 routers 150 (although it will be appreciated that a data center network may include fewer or more layer 3 routers 150, that 3 routers 150 may support fewer or more layer 2/3 switches 140, that each of the layer 2/3 switches 130 may or may not be redundantly connected to multiple layer 3 routers 150, or the like). The layer 2/3 switches 140 also are communicatively connected to each other.

The layer 3 routers 150 each are communicatively connected to the communication network 160, such that each of the layer 3 routers 150 may function as a gateway between the communication network 160 and other elements of the exemplary data center network 100. The layer 3 routers 150 also are communicatively connected to each other.

As depicted in FIG. 1, the exemplary data center network 100 also includes a plurality of redundancy elimination (RE) components 180 configured to provide RE functions within exemplary data center network 100 and an RE controller 190 configured to control use of the RE components 180 to provide RE functions (RE encoding and RE decoding) within exemplary data center network 100. The RE controller 190 is depicted as being communicatively connected to one of the layer 3 routers 150, but it will be appreciated that the RE controller 190 may be deployed at any suitable location within the data center network 100.

The use of RE components 180 within data center network 100 enables the RE capability of the data center network 100 to be distributed across the data center network 100. The use of RE controller 190 to control use of RE components 180 within data center network 100 enables evaluation of use of various combinations of RE components 180 to provide RE functions within the data center network 100, thereby enabling selection of sets of RE components 180, to be used to provide RE functions for sets of VMs 110, based on information associated with the VMs 110 in the sets of VMs 110, the topology of the data center network 100, communication patterns between VMs 110 of the sets of VMs 110, and the like, as well as various combinations thereof. In this manner, the amount of RE realized within the data center network 100 may be improved while also accounting for use of computational resources to provide such RE functions.

The use of RE components 180, under the controller of RE controller 190, to reduce or eliminate redundant traffic may be provided within data center network 100 in any suitable manner. The use of RE components 180 to reduce or eliminate redundant traffic may be supported for all VMs 110 within data center network 100 or a subset of VMs 110 within data center network 100. The use of RE components 180 to reduce or eliminate redundant traffic may be provided by the data center provider as a free service for tenant VMs 110 within the data center network 110, offered by the data center provider as a paid service which may be used by tenant VMs 110 within the data center network 110, or the like. It will be appreciated that use of RE components 180 to reduce or eliminate redundant traffic for a set of VMs may result in improvements in communication latency experienced and communication bandwidth consumed by the VMs in the set of VMs. The RE components 180 may be implemented as RE modules within devices of exemplary data center network 100, standalone RE devices communicatively connected to devices of exemplary data center network 100, or the like. In the exemplary data center network 100, the hosts 120 include a respective plurality of RE components 180 that are implemented as respective RE modules 180_{M} within the hosts 120 (within the respective hypervisors 121) and the ToR switches 130 have associated therewith a respective plurality of RE components 180 that are implemented as respective RE devices 180_{D} communicatively connected to the ToR switches 130. It will be appreciated that, although primarily depicted and described with respect to embodiments in which RE components 180 are associated with specific elements of the exemplary data center network 100 (namely, all of the hosts 120 and all of the ToR switches 130), RE components 180 may be associated with any suitable elements of the exemplary data center network 100.

The RE components 180 of data center network 100 provide a set of available RE components which are available to perform RE functions within data center network 100. The RE components 180 may be considered to be disposed at respective network locations, which may be represented in terms of the connectivity of the RE components 180 to various other elements of the data center network 100. For example, a network location of an RE module 180_{M} of a host 120 may be indicative that the RE module 180_{M} is associated with a particular host 120 that is hosting a particular set of VMs 110 and also is communicatively connected to a particular ToR switch 130. For example, a network location of an RE device 180_{D} associated with a particular ToR switch 130 may be indicative that the ToR switch 130 with which the RE device 180_{D} is associated supports a particular set of hosts 120 and is communicatively connected to specific layer 2/3 switches. The network locations of the RE components 180 may be defined in any other suitable manner.

The RE components 180 may be configured to support typical RE functions, including RE encoding functions and RE decoding functions, for reducing or even eliminating redundancy within communications between VMs 110 of the exemplary data center network 100. The RE components 180 include respective sets of packet caches 181 configured to store packets for use in performing RE encoding and RE decoding functions. The operation of RE components 180 in performing RE encoding functions and RE decoding function may be better understood by first considering the typical operation of an RE encoder/decoder pair in supporting RE for communications within a network, a description of which follows. In general, an RE encoder (having an encoder cache associated therewith) is associated with a sender and an RE decoder (having a decoder cache associated therewith) is associated with a receiver, where the sender is going to send one or more packets to the receiver. The RE encoder receives a packet to be transmitted from the sender to the receiver. The RE encoder compares the contents of the packet with the encoder cache of the RE encoder to determine if any content of the packet matches content of the encoder cache. The RE encoder, based on a determination that content of the packet matches content of the encoder cache, removes the matching content from the packet and inserts associated encoding information within the packet to form an encoded packet. The encoding information is adapted for use by the RE decoder to reconstruct the original packet received by the RE encoder. The RE encoder then transmits the encoded packet toward the intended receiver. The RE decoder receives the encoded packet. The RE decoder extracts the encoding information from the encoded packet. The RE decoder uses the encoding information and the content from the decoder cache to reconstruct the original packet sent by the sender (e.g., using the encoding information to determine the content removed from the original packet by the RE encoder and to determine where to insert the content into the encoded packet to reconstruct the original packet). The RE decoder then transmits the original packet toward the receiver. The typical operation of an RE encoder/decoder pair will be understood by one skilled in the art.

The RE components 180 may be configured to support RE functions for traffic flows in various ways. The RE components 180 may be configured to support RE functions for traffic flows on a per-flow basis. The RE components 180 may be configured to support RE functions for traffic flows by considering a set of multiple traffic flows as a group. For example, a traffic flow originating from a VM 110 may be routed through one or more sets of the RE components 180 in order to reduce or eliminate redundant content within the traffic flow based on various types of redundancy identified based on reference information (e.g., packet caches 181) which may be drawn from any suitable sources of such reference information.

The RE components 180 may be configured to collect or determine information for use by VM controller 190 in controlling use of RE components 180 to provide RE functions within exemplary data center network 100. The RE components 180 may be configured to collect statistics indicative of the amount of redundancy across various combinations of VMs 110. The RE components 180 may be configured to collect such statistics in conjunction with RE encoding and RE decoding functions performed by the RE components 180 for VMs 110 of data center network 100. The RE components 180 may be configured to report such statistics to RE controller 190. The RE components 180 may be configured to determine amounts of traffic redundancy between various combinations of VMs 110 based on statistics indicative of the amount of redundancy across various combinations of VMs 110. The RE components 180 may be configured to report the amounts of traffic redundancy between various combinations of VMs 110 to RE controller 190.

The redundancy measured by RE components 180, and RE provided by RE components 180, may include intra-node redundancy (and associated intra-node RE) or inter-node redundancy (and associated inter-node RE), descriptions of which follow.

In general, intra-node redundancy is redundancy found only in data sent or received from the same pair of nodes (e.g., VMs 110 within the context of FIG. 1 or other types of nodes within other contexts). The intra-node redundancy between a pair of VMs 110 may be measured and represented as an amount of intra-node redundancy. For example, if two VMs 110 exchange the same file twice during a given interval of time, then the amount of intra-node redundancy may be measured as 50%. It is noted that the amount of intra-node redundancy in this example may be measured as more than 50% (e.g., if the file is sufficiently large, or otherwise arranged, such that there may be redundant information within the file itself which also may be exploited for RE).

In general, inter-node redundancy is redundancy found at a node that receives data from two (or more) different nodes (e.g., VMs 110 within the context of FIG. 1 or other types of nodes within other contexts). The inter-node redundancy at a VM 110 may be measured and represented as an amount of inter-node redundancy. For example, if the same data is sent from two different VMs 110 to a destination VM 110 then one of the two transfers may be eliminated. In many data center networks, in which most of the traffic flows are constrained to be within a rack and, thus, a ToR switch is on the path of the traffic flows, there may be multiple opportunities for the ToR switch to reduce or eliminate inter-node redundancy.

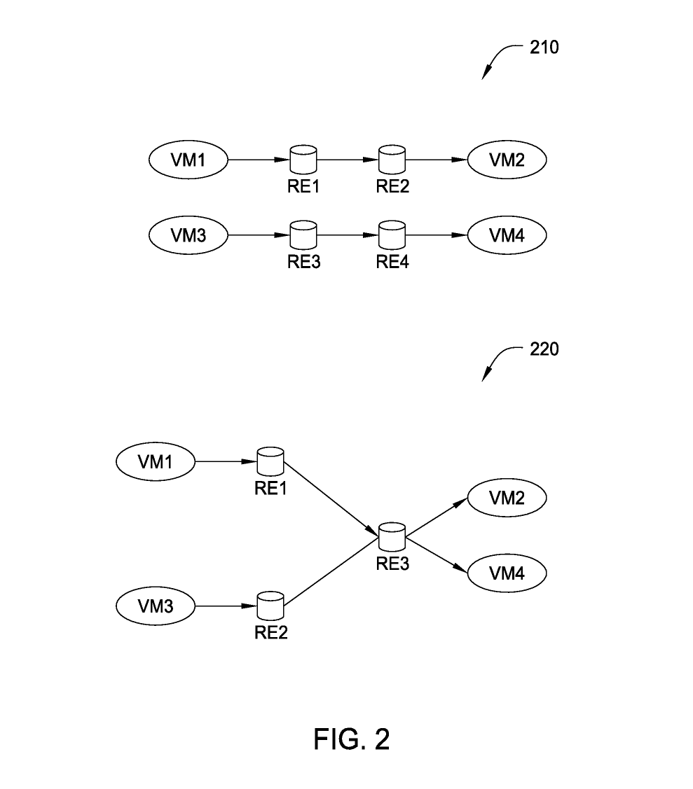

It will be appreciated that there are tradeoffs in selection of the RE components 180 to be used to provide RE for a given set of VMs 110. In the data center network 100 of FIG. 1, for example, there are tradeoffs in performing RE closer to the VMs 110 (e.g., using the RE modules 180_{M} in the hosts 120) and performing RE farther from the VMs 110 (e.g., using the RE devices 180_{D} associated with the ToR switches 130). For example, performing RE closer to the VMs 110 eliminates redundancy over a longer portion of the data path than if RE were to be performed farther from the VMs 110 (since redundancy also is eliminated from the connections between the hosts 120 and the ToR switches 130), but at the expense of only being able to observe redundancy for a smaller set of VMs 110 (the VMs 110 connected to the host 120 at which RE is performed). Similarly, for example, performing RE farther to the VMs 110 enables observation of redundancy for a larger set of VMs 110 (the VMs 110 connected to any of the hosts 120 connected to the ToR switch 140 at which RE is performed) and thus enables identification of a greater quantity of redundant content, but at the expense of only being able to eliminate redundancy over a smaller portion of the data path than if RE were to be performed closer to the VMs 110 (since redundancy is not eliminated from the connections between the hosts 120 and the ToR switches 130). As such, it will be appreciated that, in at least some embodiments, intra-node redundancy is best identified and eliminated at an RE component 180 located as close as possible to the participating VMs 110 whereas inter-node redundancy is best identified and eliminated at a common RE component 180 (e.g., common to the participating VMs 110) located as close as possible to the participating VMs 110. In other words, within the context of data center network 100, performing RE closer to the VMs 110 enables use of intra-node redundancy, whereas performing RE farther from the VMs 110 enables use of both intra-node and inter-node redundancy. An example illustrating benefits of using inter-node redundancy is depicted and described with respect to FIG. 2.

FIG. 2 depicts examples of intra-node redundancy elimination and inter-node redundancy elimination.

In example 210 of FIG. 2, in which inter-node redundancy is not used, a 20 MB file is exchanged between two pairs of VMs. Namely, a first VM (VM1) is transmitting the 20 MB file to a second VM (VM2), and a third VM (VM3) is transmitting the 20 MB file to a fourth VM (VM4). The two pairs of VMs do not share any RE components on their paths. The transmission of the 20 MB file from VM1 to VM2 traverses a first RE component (RE1) at which RE encoding is performed and a second RE component (RE2) at which RE decoding is performed. Similarly, the transmission of the 20 MB file from VM3 to VM4 traverses a third RE component (RE3) at which RE encoding is performed and a fourth RE component (RE4) at which RE decoding is performed. The transfers of the 20 MB files on the two paths are reduced to 10 MB due to use of RE, such that a total of 20 MB is transferred overall.

In example 220 of FIG. 2, in which inter-node redundancy is used, a 20 MB file is exchanged between two pairs of VMs. Namely, a first VM (VM1) is transmitting the 20 MB file to a second VM (VM2), and a third VM (VM3) is transmitting the 20 MB file to a fourth VM (VM4). The two pairs of VMs do share an RE component on their paths. The transmission of the 20 MB file from VM1 to VM2 traverses a first RE component (RE1) and the transmission of the 20 MB file from VM1 to VM2 traverses a second RE component (RE2) and, further, transmission of the two 20 MB files traverse a common RE component (RE3). Here, use of inter-node redundancy among the 20 MB file sent to VM2 and VM4 enables further reduction of the total traffic to 15 MB.

The use of intra-node and inter-node redundancy within the context of the data center network 100 of FIG. 1 may be better understood by referring again to FIG. 1 and the operation of RE controller 190 in controlling use of RE components 180 to provide RE functions within exemplary data center network 100.

The RE controller 190 is configured to control use of RE components 180 to provide RE functions within exemplary data center network 100.

The RE controller 190 may be configured, for a given set of VMs 110 expected to exchange communications within exemplary data center network 100, to select a set of RE components 180 to be used to perform RE for the communications exchanged between the VMs 110 within the given set of VMs 110. The selection of the set of RE components 180 to be used to perform RE for the communications exchanged between the VMs 110 within the given set of VMs 110 may include selection of two or more of the RE components 180 available for use in performing RE within the data center network 100 (e.g., any RE components 180 available within data center network 100 may be referred to herein as available RE components 180 of the data center network 100). The selection of the set of RE components 180 may be based on VM information associated with the VMs 110 in the given set of VMs 110, topology information associated with the exemplary data center network 100, traffic pattern information associated with traffic exchanged or expected to be exchanged between the VMs 110 in the given set of VMs 110, or the like, as well as various combinations thereof. The selection of the set of RE components 180 to be used to perform RE for the communications exchanged between the VMs 110 within the given set of VMs 110 may be initiated in response to any suitable trigger condition (e.g., at the time of provisioning of one or more VMs 110 of the set of VMs, in response to one or more requests or attempts to communication performed by one or more of the VMs 110 of the set of VMs 110, in response to association of the VMs 110 in the set of VMs 110, or the like, as well as various combinations thereof).

The RE controller 190 also may be configured, for the given set of VMs 110 exchanging communications within exemplary data center network 100, to reevaluate the set of RE components 180 being used to perform RE for the communications exchanged between the VMs 110 within the given set of VMs 110 for determining whether or not to modify the set of RE components 180 being used to perform RE for the communications exchanged between the VMs 110 within the given set of VMs 110. The reevaluation of the set of RE components 180 being used to perform RE for the communications exchanged between the VMs 110 within the given set of VMs 110 may be performed based on VM information associated with the VMs 110 in the given set of VMs 110, topology information associated with the exemplary data center network 100, RE measurement information received from RE components 180 of exemplary data center network 100 (e.g., from RE components 180 in the set of RE components 180 being used to perform RE for the communications exchanged between the VMs 110 within the given set of VMs 110, from other RE components 180 not currently included in the set of RE components 180 being used to perform RE for the communications exchanged between the VMs 110 within the given set of VMs 110, or the like, as well as various combinations thereof). The reevaluation of the set of RE components 180 to be used to perform RE for the communications exchanged between the VMs 110 within the given set of VMs 110 may be initiated periodically, in response to any suitable trigger condition (e.g., in response to a change in membership of the set of VMs 110, in response to one or more network conditions, or the like), or the like, as well as various combinations thereof. The determination as to whether or not to modify the set of RE components 180 being used to perform RE for the communications exchanged between the VMs 110 within the given set of VMs 110 may be a determination as to whether such a modification is necessary or desirable, which may be based on any suitable criteria (e.g., based on a determination that the modification will result in an increased level of RE for the set of VMs 110, based on a determination that the modification will result in an increased level of RE for the exemplary data center network 100, or the like, as well as various combinations thereof).

In other words, the selection of the set of RE components 180 used to perform RE for the communications exchanged between the VMs 110 within the given set of VMs 110 may include an initial selection of the set of RE components 180 used to perform RE for the communications exchanged between the VMs 110 within the given set of VMs 110 and one or more subsequent modifications to the set of RE components 180 used to perform RE for the communications exchanged between the VMs 110 within the given set of VMs 110.

The RE controller 190 also may be configured, for the set of RE components 180 selected to be used to perform RE for the communications exchanged between the VMs 110 within the given set of VMs 110, to determine respective packet cache sizes of the packet caches 181 of the RE components 180 in the set of RE components 180 selected to be used to perform RE for the communications exchanged between the VMs 110 within the given set of VMs 110. The determination of the packet cache sizes of the packet caches 181 of the RE components 180 in the set of RE components 180 may be based on traffic pattern information associated with the VMs 110 in the given set of VMs 110.

The RE controller 190 may be configured to perform configuration of a set of RE components 180 selected to be used to perform RE for the communications exchanged between the VMs 110 within the given set of VMs 110. The RE controller 190 may be configured to generate configuration information for use in configuring RE components 180 in the set of RE components 180 selected to be used to perform RE for the communications exchanged between the VMs 110 within the given set of VMs 110. The configuration information for a given RE component may include one or more of an indication of the set of VMs 110 for which RE is to be performed, a packet cache size of the packet cache 181 to be used by the RE component 180 to perform RE, or the like, as well as various combinations thereof. The RE controller 190 may propagate the configuration information to the RE components 180 in any suitable manner (e.g., using any suitable formatting of configuration information, using any suitable message types, or the like).

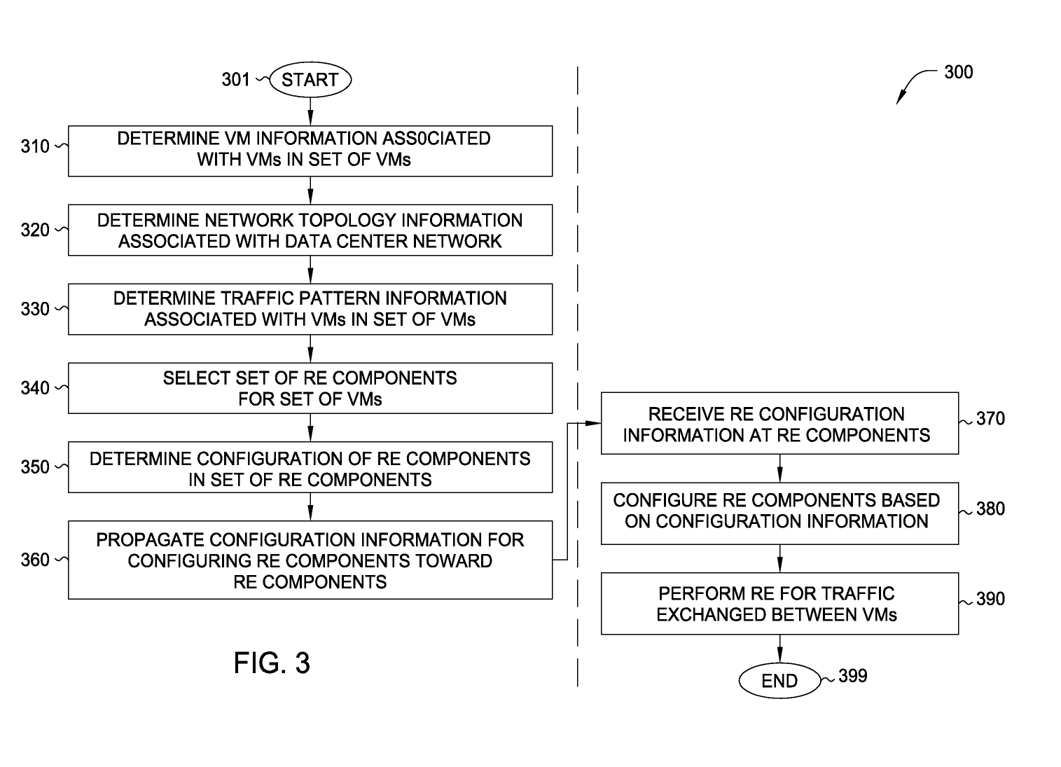

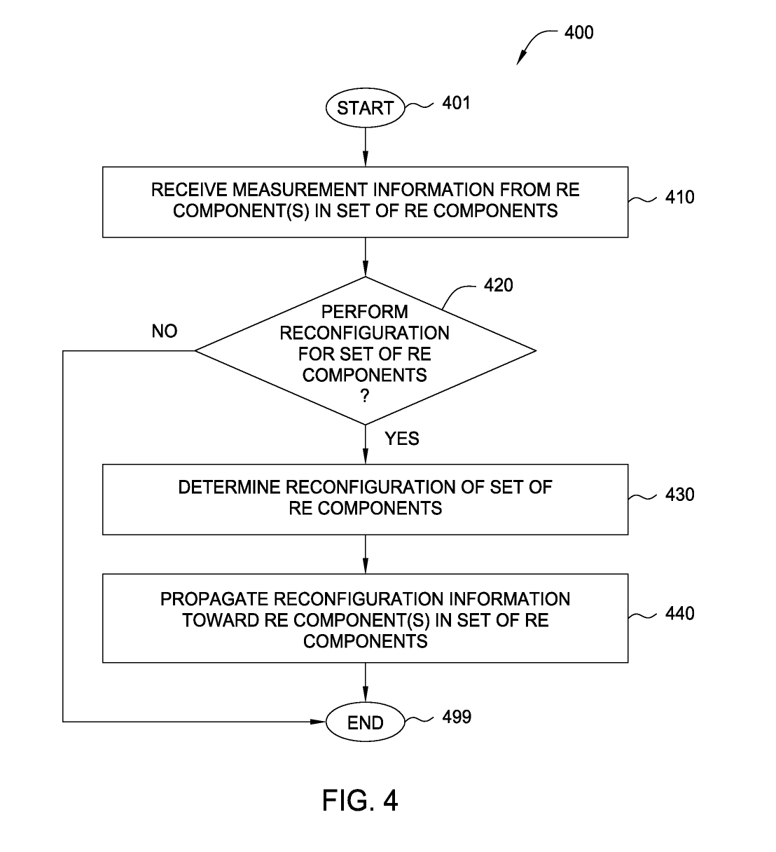

The operation of RE controller 190 in controlling use of RE components 180 to provide RE functions within exemplary data center network 100 may be better understood by way of reference to FIGS. 3-4.

FIG. 3 depicts one embodiment of a method for configuring a set of redundancy elimination components to perform redundancy elimination for a set of virtual machines within the exemplary within the exemplary data center network of FIG. 1.

In the method 300 of FIG. 3, a portion of the steps are performed by an RE controller (e.g., RE controller 190 depicted and described with respect to FIG. 1) and a portion of the steps are performed by RE components (e.g., RE components 180 depicted and described with respect to FIG. 1).

In the method 300 of FIG. 3, the selection and configuration may be an initial selection and configuration of RE components or a subsequent reconfiguration of RE components (e.g., reconfiguration of an existing set of RE components, selection of a different set of RE components, or the like, as well as various combinations thereof).

In the method 300 of FIG. 3, it will be appreciated that, although primarily depicted and described herein as being performed serially, at least a portion of the steps of method 300 may be performed contemporaneously or performed in a different order than depicted and described in FIG. 3.

At step 301, method 300 begins.

At step 310, the RE controller determines VM information associated with the set of VMs. This VM information may include the number of VMs in the set of VMs, identification of the VMs in the set of VMs, network locations of the VMs in the set of VMs (e.g., respective hosts with which the VMs are associated), application information associated with the VMs in the set of VMs (e.g., the type of application(s) to be used, the application(s) to be used, or the like), or the like, as well as various combinations thereof.

At step 320, the RE controller determines topology information associated with the data center network. The topology information may include information indicative of network elements included within the data center network, information indicative of connectivity between network elements included within the data center network, information identifying the network elements of the data center network having RE components associated therewith, or the like, as well as various combinations thereof. The topology information may include information indicative of network locations of the RE components within the data center network.

At step 330, the RE controller determines traffic pattern information associated with the set of VMs.

In at least some embodiments, during an initial selection of RE components for the set of VMs, the traffic pattern information may include expected traffic patterns for communications between the VMs in the set of VMs, which may be based on one or more of historical information (e.g., information indicative of traffic patterns previously supported by the data center network for similar VMs (e.g., VMs located at similar network locations within the data center network, VMs supporting the same or similar applications or application types, or the like), information indicative of traffic patterns previously supported by the data center network, representative traffic pattern information associated with one or more other data center networks, traffic pattern simulation information, or the like as well as various combinations thereof.

In at least some embodiments, after RE components have been configured for the set of VMs, the traffic pattern information may include real traffic pattern information measured by the RE components and reported to the RE controller. In at least some such embodiments, the traffic pattern information also may include one or more of the types of information described as being used during initial selection of RE components for the set of VMs (e.g., such information may be used to supplement real traffic pattern information measured by the RE components and reported to the RE controller).

At step 340, the RE controller selects a set of RE components for the set of VMs. The set of RE components includes two or more RE components of the data center network.

The selection of the set of RE components for the set of VMs may be performed in a manner tending to maximize an amount of RE achieved for the communications exchanged between the VMs in the set of VMs.

The selection of the set of RE components for the set of VMs may include an initial selection of a set of RE components, a subsequent selection of a set of RE components (e.g., modification of the existing set of RE components selected for the set of VMs based on reevaluation of the existing set of RE components selected for the set of VMs), or the like.

In at least some embodiments, during an initial selection of RE components for the set of VMs, the set of RE components may be selected based on the VM information and the topology information. The set of RE components also may be selected based on the expected traffic pattern information.

In at least some embodiments, during a subsequent selection of RE components for the set of VMs, the set of RE components may be selected based on one or more of the VM information, the topology information, the traffic pattern information (e.g., measured traffic pattern information and, optionally, expected traffic pattern information), or the like, as well as various combinations thereof. As described herein, reevaluation of the set of RE components selected for the set of VMs may be performed periodically, in response to one or more trigger conditions, or the like as well as various combinations thereof. The reevaluation of the set of RE components selected for the set of VMs may or may not result in modification of the set of RE components selected for the set of VMs. For example, reevaluation of the set of RE components may result in a determination that the existing set of RE components selected for the set of VMs should be maintained. Similarly, for example, reevaluation of the set of RE components may result in a determination that the existing set of RE components selected for the set of VMs should be modified (e.g., via elimination of use of one or more of the RE components of the existing set of RE components, via addition of one or more other RE components to the set of RE components, or the like, as well as various combinations thereof). The reevaluation of set of RE components selected for the set of VMs may be performed in response to or based on one or more of a change in the VM information (e.g., migration of one or more existing VMs of the set of VMs to one or more different network locations, removal of one or more existing VMs from the set of VMs, addition of one or more new VMs to the set of VMs, modification of an application type(s) or application(s) for which the set of VMs is being used, or the like), a change in the topology information (e.g., addition of a new network element(s) or communication link(s) to the data center network, failure of a network element or communication link of the data center network, or the like), a change in the measured traffic pattern information (e.g., determined based on traffic pattern measurements received from RE components of the data center network), Information indicative of a level of RE realized via use of the set of RE components (e.g., reported by the RE component, determined based on measurement information received from the RE components, or the like), or the like, as well as various combinations thereof.

At step 350, the RE controller determines configurations of the RE components in the set of RE components.

The determination of configurations of the RE components in the set of RE components may include determining packet cache sizes of the packet caches of the RE components.

The packet cache sizes of the packet caches of the RE components in the set of RE components may be determined based on the traffic pattern information. For example, during an initial selection of RE components for the set of VMs, the packet cache sizes of the packet caches may be selected based on expected traffic pattern information. For example, during a subsequent selection of RE components for the set of VMs or a subsequent analysis of packet cache sizes of the packet caches of the set of VMs, the packet cache sizes of the packet caches may be selected based on measured traffic pattern information received from the RE components.

The packet cache sizes of the packet caches of the RE components may be set by considering the VMs in the set of VMs in conjunction with each other or independent of each other. For example, the packet cache sizes of the packet caches of the RE components may be set by determining an amount of traffic supported, or to be supported, by the VMs in the set of VMs, determining an amount of memory to allocate for the packet caches of the set of VMs, and then determining apportionment of the amount of memory for the packet caches of the set of VMs to the respective packet caches of the set of VMs. Similarly, for example, the packet cache sizes of the packet caches of the RE components may be set by determining amounts of traffic supported, or to be supported, by the respective VMs in the set of VMs, and determining amounts of memory to allocate for the packet caches of the respective VMs of set of VMs. The packet cache sizes of the packet caches of the RE components also may be set by considering other sets of VMs of the data center (e.g., where there is a total amount of packet cache memory available for the data center, the amounts of packet cache memory to be allocated to the sets of VMs of the data center network may be based on traffic pattern information associated with the respective sets of VMs of the data center network).

The packet cache sizes of the packet caches of the RE components may be set based on traffic pattern information (e.g., the amount of traffic supported, or expected to be supported, by the VMs in the set of VMs. In at least some embodiments, the packet cache sizes of the packet caches may be set such that VMs supporting more traffic than other VMs are allocated larger packet cache sizes than the other VMs. In at least some embodiments, the packet cache sizes of the packet caches may be set to be proportional to the amounts of traffic supported by the VMs. In at least some embodiments, the packet cache sizes of the packet caches may be set based on measurements of the marginal utilities of the packet caches (e.g., the amount of increase in RE achieved for an amount of increase in the packet cache size of the packet cache). In at least some embodiments, the packet cache sizes of the packet caches may be increased based on a determination that the marginal utilities of the packet caches have increased or may be decreased based on a determination that the marginal utilities of the packet caches have decreased.

The reevaluation of the packet cache sizes of the packet caches may be performed periodically, in response to one or more trigger conditions (e.g., a change in traffic patterns, addition of one or more new VMs, removal of one or more existing VMs, conditions in the data center network, or the like), or the like, as well as various combinations thereof.

At step 360, the RE controller propagates configuration information for use in configuring RE components in the set of RE components toward the RE components in the set of RE components.

At step 370, the RE components in the set of RE components receive the configuration information from the RE controller.

At step 380, the RE components in the set of RE components configured themselves based on the configuration information received from the RE controller.

At step 390, the RE components in the set of RE components perform RE for traffic exchanged by the VMs in the set of VMs.

At step 399, method 300 ends.

FIG. 4 depicts one embodiment of a method for reconfiguring a set of redundancy elimination components based on measurement information received from the redundancy elimination components.

In the method 400 of FIG. 4, it will be appreciated that, although primarily depicted and described herein as being performed serially, at least a portion of the steps of method 400 may be performed contemporaneously or performed in a different order than depicted and described in FIG. 4.

At step 401, method 400 begins.

At step 410, measurement information is received from RE components in set of RE components. The measurement information may include traffic pattern information indicative of traffic patterns associated with communications between VMs in the set of VMs, measures of the amount of traffic redundancy between VMs in the set of VMs, or the like.

At step 420, a determination is made as to whether or not to perform a reconfiguration for the set of RE components. The determination is made based at least in part on the measurement information (and, optionally, on one or more of VM information associated with the VMs in the set of VMs, topology information associated with the data center network, or the like). If a determination is made not to perform a reconfiguration for the set of RE configuration modules, method 400 proceeds to step 499 where method 400 ends. If a determination is made to perform a reconfiguration for the set of RE components, method 400 proceeds to step 430.

At step 430, reconfiguration of the set of RE components is determined. The determination of the reconfiguration of the set of RE components is based at least in part on the measurement information (and, optionally, on one or more of VM information associated with the VMs in the set of VMs, topology information associated with the data center network, or the like). The reconfiguration of the set of RE components may include one or more of removing one or more existing RE components from the set of RE components for the set of VMs, adding one or more new RE components to the set of RE components for the set of VMs, determining a change in the packet cache size(s) to be used for a packet cache(s) of one or more of the RE components, or the like, as well as various combinations thereof.

At step 440, configuration information, for use in configuring RE components in the set of RE components, is propagated toward the RE components in the set of RE components.

At step 499, method 400 ends.

It will be appreciated that, although primarily depicted and described as separate processes, various portions of method 300 of FIG. 3 and method 400 of FIG. 4 may be combined within a common process.

In at least some embodiments of method 300 of FIG. 3 or method 400 of FIG. 4, controlling the set of RE components used to provide RE for the set of VMs may be performed as follows. The two closest common RE components (most likely, but not necessarily, the ToR switches) are determined based on the topology of the VMs in the set of VMs, and a certain amount of cache size is allocated to these RE components. The RE components measure the amount of traffic redundancy between downstream VMs (e.g., based on statistics indicative of the amount of redundancy across different VMs, which may be measured by the RE components during encoding/decoding of packets exchanged between the various VMs) and report the traffic redundancy measurement information to the RE controller. The RE controller periodically determines whether inter-node redundancy satisfies a threshold contributed by the downstream VMs. If the inter-node redundancy threshold is not satisfied, the RE controller identifies one or more elements of the data center network which are the largest contributors to the redundancy and selects one or more RE components that are closest to the elements identified as the one or more largest redundancy contributors (e.g., which may be thought of as moving the RE functions closer to the elements identified as the one or more largest redundancy contributors). It will be appreciated, however, that migration of the RE functions in this manner, while reducing traffic between the RE component and the destination (and, thus, reducing overall traffic for the set of VMs), may eliminate the ability to perform inter-node RE. This process may continue to be repeated until the set of RE components used for the set of VMs cannot be moved any closer to the VMs. It will be appreciated that redundancy measurement may continue on the common element(s) (e.g., the ToR switches), because conditions may arise in which it becomes necessary or desirable to move the RE functions back to the RE components associated with the common elements (e.g., the ToR switches). The RE controller also may determine, based on redundancy measurement on the common element(s) (e.g., based on a determination that the traffic pattern changes to include at least a threshold amount of inter-node redundancy), that RE functions are to be moved back to the RE components associated with the common elements (e.g., away from the VMs) to exploit this higher level of inter-node redundancy. It will be appreciated that redundancy measurement may continue on elements closer to the VMs (e.g., hosts), because conditions may arise in which it becomes necessary or desirable to move the RE functions back to the RE components associated with elements closer to the VMs (e.g., the hosts).

In at least some embodiments of method 300 of FIG. 3 or method 400 of FIG. 4, determining the packet cache sizes of the packet caches for the RE components of the set of RE components may be performed as follows. Namely, the packet cache sizes of the packet caches for the RE components may be based on a heuristic which is based on an observation that there is a skew in the traffic matrix of the data center network such that a relatively small fraction of the VMs of the data center contribute a majority of the traffic exchanged within the data center. As a result, in many data center networks, not all of the traffic flows of the data center network can significantly benefit from RE. In at least some embodiments, memory for use in packet caches may be allocated based on the respective amounts of traffic associated with the VMs. It will be appreciated that use of larger packet cache sizes for VMs generating more traffic may tend to lead to larger amounts of RE realized within the data center network. It also will be appreciated, however, that traffic patterns may change over time (e.g., such that the amounts of traffic associated with the VMs changes over time) and, thus, that the packet cache sizes may be adjusted based on changes in the traffic patterns. The determination as to whether to adjust packet cache sizes of the packet caches may be performed periodically, in response to one or more trigger conditions, or the like, as well as various combinations thereof. The determination as to whether to adjust packet cache sizes of the packet caches may be based on measurements of the marginal utilities of the packet caches (e.g., the amount of increase in RE achieved for an amount of increase in the packet cache size of the packet cache). In at least some embodiments, increases in packet cache sizes are suspended based on a determination that the marginal utilities of the packet caches for the set of VMs stabilizes. In at least some embodiments, packet cache sizes of the packet caches are reduced for the set of VMs based on one or more of a determination that the marginal utilities of the packet caches for the set of VMs stabilizes, a determination that the volume of traffic supported for the set of VMs decreases, or the like.

It will be appreciated that various portions of method 300 and method 400 may be combined to support configuration/reconfiguration of a set of RE components based on various combinations of input information.

It will be appreciated that efficient use of RE may depend upon synchronization between the encoder and decoder (such that the decoder cache includes the packets included within the encoder) involved in RE.

In at least one embodiment in which cache sizes of the caches of the RE components may be reconfigured, reconfiguration of the cache sizes of the caches of the RE components may be performed by (1) increasing the cache size of the decoder cache and then (2) increasing the cache size of the encoder cache after a determination is made that the cache size of the decoder cache has been increased. In one embodiment, the RE controller (1) initiates an increase in the cache size of the decoder cache by sending a cache reconfiguration instruction to the decoder for causing the decoder to increase the cache size of the decoder cache and (2) initiates an increase in the cache size of the encoder cache by sending a cache reconfiguration instruction to the encoder, for causing the encoder to increase the cache size of the encoder cache, based on a determination that the cache size of the decoder cache has been increased. This prevents a situation in which packets available to the encoder, but not available to the decoder, are used to encode packets at the encoder.

In at least one embodiment in which cache sizes of the caches of the RE components may be reconfigured, reconfiguration of the cache sizes of the caches of the RE components may be performed by (1) decreasing (or removing) the cache size of the encoder cache and then (2) decreasing (or removing) the cache size of the decoder cache after a determination is made that certain encoded packets (namely, the encoded packets that were encoded by the encoder before the cache size of the encoder cache was modified) have been received and decoded by the decoder. In one embodiment, the RE controller (1) initiates a reduction in the cache size of the encoder cache by sending a cache reconfiguration instruction to the encoder for causing the encoder to decrease (which may include a full removal of the encoder cache) the cache size of the encoder cache and (2) initiates a reduction in the cache size of the decoder cache by sending a cache reconfiguration instruction to the decoder, for causing the decoder to decrease (which may include a full removal of the decoder cache) the cache size of the decoder cache, based on a determination that packets encoded by the encoder before the cache size of the encoder cache was decreased have been received and decoded by the decoder cache. This ensures that encoded packets in transit between the encoder and the decoder may be decoded on the decoder before the cache size of the decoder cache is modified (e.g., while all of the packets which may have been used by the encoder to encode packets are still available to the decoder for use in decoding).

It will be appreciated that, although primarily depicted and described with respect to embodiments in which the set of VMs includes a pair of VMs communicating via a single path through the data center network, the set of VMs may include two or more VMs which may communicate via one or more paths through the data center network.

It will be appreciated that, although primarily depicted and described with respect to embodiments in which a single RE function (e.g., RE encoding upstream and RE encoding downstream) is provided for a given path between VMs in a set of VMs, in at least some embodiments multiple RE functions may be provided within multiple portions of a given path between the VMs in a set of VMs (e.g., providing multiple pairs of RE encoding and decoding functions serially along a given path between VMs a set of VMs).

It will be appreciated that, although primarily depicted and described with respect to embodiments in which a set of VMs is evaluated as a whole, in at least some embodiments a set of VMs may be evaluated as a plurality of subsets of VMs. In at least some embodiments, for example, based on identification of multiple subsets of VMs where each subset of VMs is responsible for a threshold portion of redundancy, one or more RE components may be allocated for each subset of VMs.

It will be appreciated that, although primarily depicted and described with respect to embodiments in which a set of VMs is evaluated independent of other sets of VMs supported by the data center network, in at least some embodiments a set of VMs may be evaluated based on information associated with one or more other sets of VM supported by the data center network. In at least some embodiments, for example, based on identification of multiple sets of VMs where each set of VMs is responsible for a threshold portion of redundancy, a set of RE components may be allocated for each set of VMs.

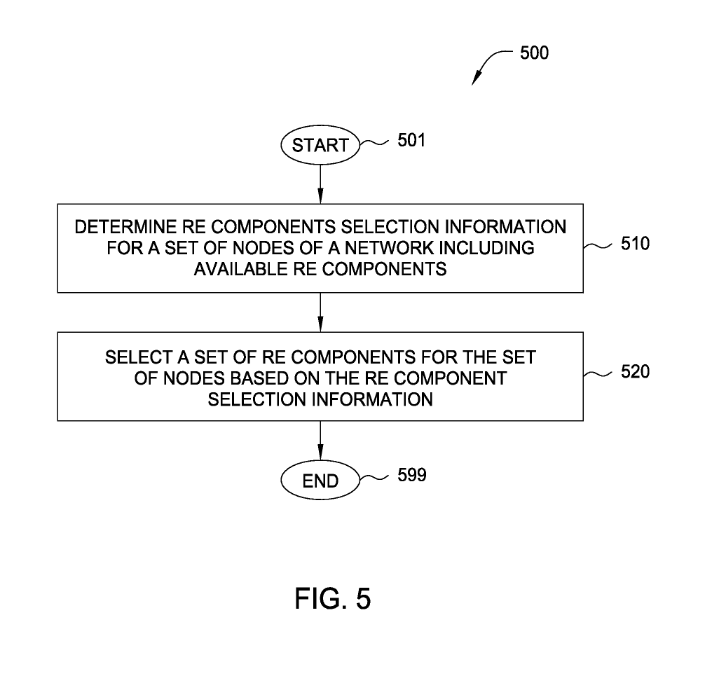

It will be appreciated that, although primarily depicted and described herein with respect to embodiments in which dynamic RE is performed for communication between specific types of nodes communicating via a specific type of communication network (namely, between VMs of a data center network), various embodiments of dynamic redundancy elimination may be utilized for communication between various other types of nodes communicating via various other types of communication networks (e.g., user endpoint devices communicating via an Internet Service Provider (ISP) network, user endpoint devices communicating via an enterprise network, network-based nodes communicating via a communication service provider network, or the like). Accordingly, various references herein which are specific to the context of a data center network may be read more generally for other types of networks (e.g., references herein to a data center network may be read more generally as references to a communication network, references herein to specific network elements of the data center network may be read more generally as references to network elements, references herein to VMs may be read more generally as references to nodes or communication endpoint devices, or the like). An exemplary method for selecting a set of RE components of a communication network to provide RE for a set of nodes configured to communicate via the communication network is depicted and described with respect to FIG. 5.

FIG. 5 depicts one embodiment of a method for selecting a set of redundancy elimination components of a network to perform redundancy elimination for a set of nodes configured to communicate via the network.

In the method 500 of FIG. 5, it will be appreciated that the set of RE components is selected from a set of available RE components which are available to provide RE for communications within the network.

In the method 500 of FIG. 5, it will be appreciated that, although primarily depicted and described herein as being performed serially, at least a portion of the steps of method 500 may be performed contemporaneously or performed in a different order than depicted and described in FIG. 5.

At step 501, method 500 begins.

At step 510, RE component selection information is determined for the set of nodes of the network. The RE component selection information may include one of more of information associated with the nodes (e.g., indications of network locations of the nodes, indications of one or more application types or applications used by the nodes to communicate, or the like), information associated with the available RE components (e.g., RE functions supported by the RE components, network locations of the RE components, or the like), network topology information (e.g., information indicative of relative network locations of the nodes and the RE components, network connectivity between network elements of the network, or the like), traffic pattern information associated with the set of nodes (e.g., expected traffic patterns for traffic expected to be exchanged between the nodes, actual traffic patterns for traffic exchanged between the nodes, or the like), measurement information (e.g., traffic pattern measurement information, RE measurement information, or the like), or the like, as well as various combinations thereof.

At step 520, the set of RE components is selected, from the set of available RE components, for the set of nodes based on the RE component selection information associated with the set of nodes,

At step 599, method 500 ends.

It will be appreciated that, although omitted from FIG. 5 for purposes of clarity, any of the various features of FIG. 3 or FIG. 4 also may be utilized to support RE for communications between the nodes depicted and described with respect to FIG. 5 (e.g., features primarily described within the context of a data center network may be adapted for use in the more general network of FIG. 5).

It will be appreciated that functions described herein as redundancy elimination (RE) functions also may be referred to as redundancy reduction functions, traffic deduplication functions, traffic acceleration functions, or the like.

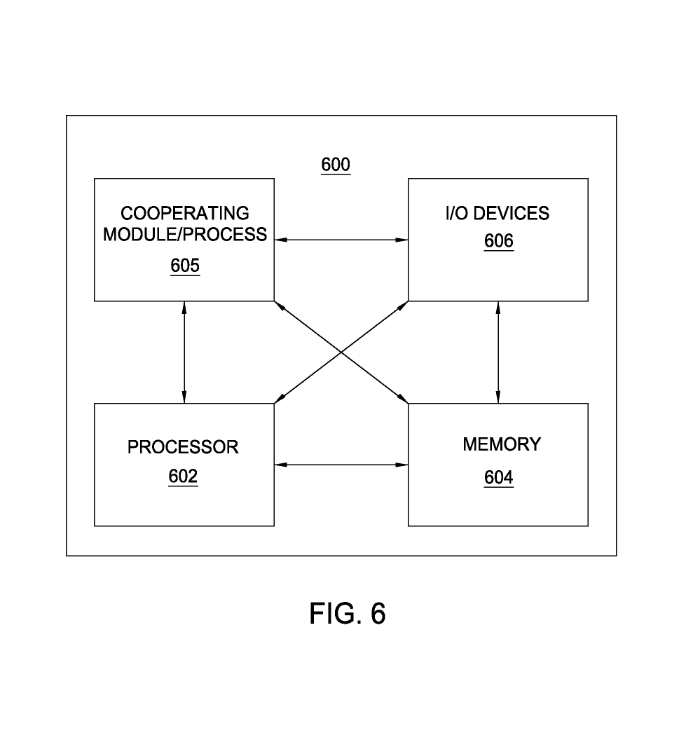

FIG. 6 depicts a high-level block diagram of a computer suitable for use in performing functions described herein.

The computer 600 includes a processor 602 (e.g., a central processing unit (CPU) or other suitable processor(s)) and a memory 604 (e.g., random access memory (RAM), read only memory (ROM), and the like).

The computer 600 also may include a cooperating module or process 605. The cooperating process 605 can be loaded into memory 604 and executed by the processor 602 to implement functions as discussed herein and, thus, cooperating process 605 (including associated data structures) can be stored on a computer readable storage medium, e.g., RAM memory, magnetic or optical drive or diskette, and the like.

The computer 600 also may include one or more input/output devices 606 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 600 depicted in FIG. 5 provides a general architecture and functionality suitable for implementing functional elements described herein or portions of functional elements described herein. For example, the computer 600 provides a general architecture and functionality suitable for implementing one or more of a VM 110, a host 120, a hypervisor 121, a ToR switch 130, a layer 2/3 switch 140, a layer 3 router 150, an element of communication network 160, an RE component 180, the RE controller 190, or the like.

It will be appreciated that the functions depicted and described herein may be implemented in hardware or a combination of software and hardware, e.g., using a general purpose computer, via execution of software on a general purpose computer so as to provide a special purpose computer, using one or more application specific integrated circuits (ASICs) or any other hardware equivalents, or the like, as well as various combinations thereof.

It will be appreciated that at least some of the method steps discussed herein may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods or techniques described herein are invoked or otherwise provided. Instructions for invoking the inventive methods may be stored in fixed or removable media, transmitted via a data stream in a broadcast or other signal bearing medium, or stored within a memory within a computing device operating according to the instructions.

It will be appreciated that the term “or” as used herein refers to a non-exclusive “or” unless otherwise indicated (e.g., “or else” or “or in the alternative”).

It will be appreciated that, while the foregoing is directed to various embodiments of features present herein, other and further embodiments may be devised without departing from the basic scope thereof.

What is claimed is:

1. An apparatus for supporting redundancy elimination (RE) in a network, the apparatus comprising:
a processor and a memory communicatively connected to the processor, the processor configured to:
determine RE component selection information for a set of nodes of a network, the network comprising a plurality of network elements and a set of available RE components available to perform RE functions within the network, the set of available RE components comprising at least three RE components; and
select a set of RE components for the set of nodes based on the RE component selection information, wherein the set of RE components is selected from the set of available RE components and comprises at least two of the available RE components.

2. The apparatus of claim 1, wherein the RE component selection information comprises network location information indicative of a plurality of network locations of the nodes relative to a plurality of network locations of the available RE components.

3. The apparatus of claim 1, wherein the RE component selection information comprises node information associated with one or more of the nodes.

4. The apparatus of claim 3, wherein the node information comprises at least one of a respective plurality of network locations of the nodes, at least one application type of at least one application to be used by at least a portion of the nodes, or at least one application to be used by at least a portion of the nodes.

5. The apparatus of claim 1, wherein the RE component selection information comprises topology information associated with the network.

6. The apparatus of claim 5, wherein the topology information comprises at least one of a respective plurality of network locations of the available RE components, information associated with one or more of the network elements of the network, or information associated with connectivity between ones of the network elements of the network.

7. The apparatus of claim 1, wherein the RE component selection information comprises traffic pattern information for traffic associated with communications between the nodes.

8. The apparatus of claim 7, wherein the traffic pattern information comprises at least one of:
expected traffic pattern information associated with traffic expected to be exchanged between the nodes; or
measured traffic pattern information associated with traffic exchanged between the nodes.

9. The apparatus of claim 1, wherein the RE component selection information comprises measurement information received from at least one of the available RE components.

10. The apparatus of claim 9, wherein the measurement information comprises at least one of:
measurement information associated with traffic patterns of traffic exchanged between the nodes; or
measurement information indicative of an amount of RE measured by at least one of the available RE components.

11. The apparatus of claim 1, wherein the processor is configured to:
determine additional RE component selection information for the set of nodes of the network; and
modify the set of RE components for the set of nodes based on the additional RE component selection information.

12. The apparatus of claim 1, wherein the processor is configured to:
determine an amount of RE provided by at least one of the available RE components; and
initiate reconfiguration of the set of RE components for the set of nodes based on the amount of RE provided by the at least one of the available RE components.

13. The apparatus of claim 1, wherein the available RE components comprise a respective plurality of encoders for performing RE encoding, a respective plurality of decoders for performing RE decoding, and a respective plurality of packets caches.

14. The apparatus of claim 13, wherein the processor is configured to:
determine a plurality of packet cache sizes for the respective packet caches of the respective RE components of the set of RE components.

15. The apparatus of claim 13, wherein the processor is configured to determine the packet cache sizes for the packet caches based on traffic pattern information associated with communications between the nodes.

16. The apparatus of claim 1, wherein a first one of the selected RE components is configured to perform RE encoding for at least a portion of the nodes in the set of nodes based on an encoder packet cache and a second one of the selected RE components is configured to perform RE decoding for at least a portion of the nodes in the set of nodes based on a decoder packet cache, wherein the processor is configured to:
initiate an increase in a decoder packet cache size of the decoder packet cache; and
based on a determination that the decoder packet cache size of the decoder packet cache has been increased, initiate an increase in an encoder packet cache size of the encoder packet cache.

17. The apparatus of claim 1, wherein a first one of the selected RE components is configured to perform RE encoding for at least a portion of the nodes in the set of nodes based on an encoder packet cache and a second one of the selected RE components is configured to perform RE decoding for at least a portion of the nodes in the set of nodes based on a decoder packet cache, wherein the processor is configured to:
initiate a decrease in an encoder packet cache size of the encoder packet cache; and
based on a determination that packets encoded prior to the decrease in the encoder packet cache size of the encoder packet cache have been received and decoded by the second one of the RE components, initiate a decrease in a decoder packet cache size of the decoder packet cache.

18. The apparatus of claim 1, wherein the network comprises a data center network, wherein the nodes comprise virtual machines (VMs) of the data center network.

19. A computer-readable storage medium storing instructions which, when executed by a computer, cause the computer to perform a method for supporting redundancy elimination (RE) in a network, the method comprising:
determining RE component selection information for a set of nodes of a network, the network comprising a plurality of network elements and a set of available RE components available to perform RE functions within the network, the set of available RE components comprising at least three RE components; and
selecting a set of RE components for the set of nodes based on the RE component selection information, wherein the set of RE components is selected from the set of available RE components and comprises at least two of the available RE components.

20. A method for supporting redundancy elimination (RE) in a network, the method comprising:
using a processor and a memory for:
determining RE component selection information for a set of nodes of a network, the network comprising a plurality of network elements and a set of available RE components available to perform RE functions within the network, the set of available RE components comprising at least three RE components; and
selecting a set of RE components for the set of nodes based on the RE component selection information, wherein the set of RE components is selected from the set of available RE components and comprises at least two of the available RE components.
